(19) United States
(12) Patent Application Publication
(10) Pub. No.: US 2025/0296648 A1
(43) Pub. Date: Sep. 25, 2025

(54) PALS Panel Accessory Mounting System for a Bicycle

(71) Applicant: Thorbin Atwell-Donaghey, Longmont, CO (US)

(72) Inventor: Thorbin Atwell-Donaghey, Longmont, CO (US)

(21) Appl. No.: 19/088,083

(22) Filed: Mar. 24, 2025

Related U.S. Application Data
(60) Provisional application No. 63/568,516, filed on Mar. 22, 2024.

(51) Int. Cl. B62J 11/00

(52) U.S. Cl. CPC B62J 11/00

(57) ABSTRACT

A mounting system for a PALS panel for attachment to a bike is described. Embodiments of the mounting system are configured to secure a PALS panel to a front of a bike. One or more accessories can be secured to the PALS panel.

### CROSS-REFERENCE TO RELATED APPLICATION

This application claims the benefit of U.S. Provisional Application No. 63/568,516, filed Mar. 22, 2024.

### BACKGROUND

When riding a bike for transportation or recreation, the stowage of various items and supplies is often necessary. Numerous mounts and mounting systems have been created over the years to serve this purpose including, but not limited to, water bottle holders, phone holders, seat bags, racks and panniers. The associated storage can be used to store items necessary for a ride, such as tools, air pumps, patch kits, food, and water. Further, the storage can be used to carry items from one place to another, such as a laptop or briefcase that a rider needs when commuting between home and office.

The various storage solutions are typically attached to a bicycle using mounting brackets specifically designed for a particular storage solution. For instance, the bracket used to mount a handlebar bag to a handlebar can only be used with the handlebar bag and is not suitable to mount a phone or water bottle to the handlebar. Mounting these other items would require other mounting brackets and mounting solutions.

PALS stands for Pouch Attachment Ladder System and originally was conceived by the United States Army as a grid of fabric webbing distributed on tactical equipment, such as backpacks and vests, and designed to hold various items such as, but not limited to, holsters, knife sheathes, and magazine pouches. PALS panels are an outgrowth of the original system comprising a substantially rigid panel having an array of slots and/or opening distributed therethrough. The panels can be mounted to any suitable substrate using one or more of the slots, and permit the attachment of any number of items with the use of bolts, zip ties, straps and T-nuts to the remaining slots.

### BRIEF DESCRIPTION OF THE DRAWINGS

FIG. 1 is a front view of a PALS panel according to one embodiment of the present invention.

FIG. 2 is an exploded side view of a handlebar mounting system, a PALS panel, and a handlebar of a bike according to one embodiment of the present invention.

FIG. 3 is a front perspective view of a handlebar mounting system and a PALS panel attached to a handlebar according to one embodiment of the present invention.

FIG. 4 is a back perspective view of a handlebar mounting system and a PALS panel attached to a handlebar according to one embodiment of the present invention

FIG. 5 is an exploded side view of a fork steerer tube mounting system and a PALS panel according to one embodiment of the present invention.

FIG. 6 is a side view of a fork steerer tube mounting system and a PALS panel attached to a fork steerer tube of a bike according to one embodiment of the present invention.

FIG. 7 is front perspective view of a fork steerer tube mounting system and a PALS panel attached to a fork steerer tube of a bike according to one embodiment of the present invention.

FIGS. 8-14 include several different views of a second fork steerer tube mounting system and a PALS panel attached to a fork steerer tube of a bike according to one embodiment of the present invention,

FIGS. 15-16 include a couple views of an orbiter body according to one embodiment of the present invention.

### DESCRIPTION

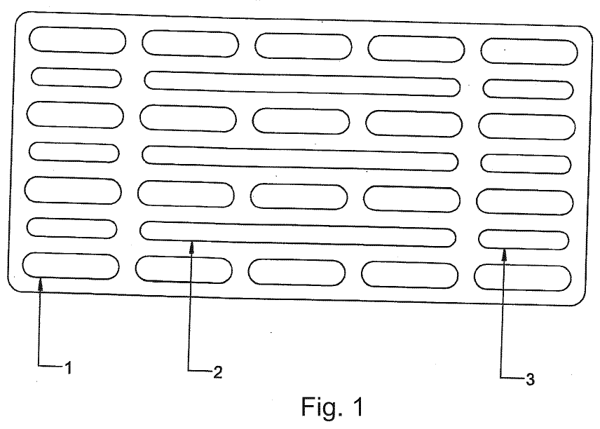

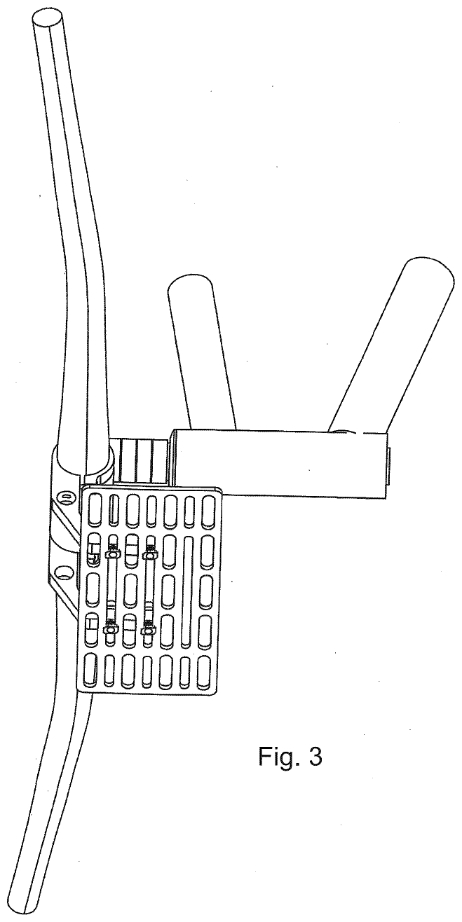

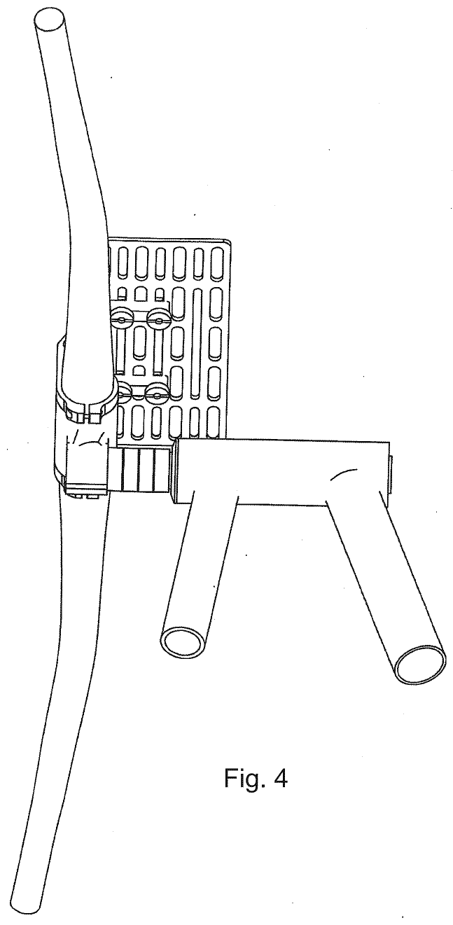

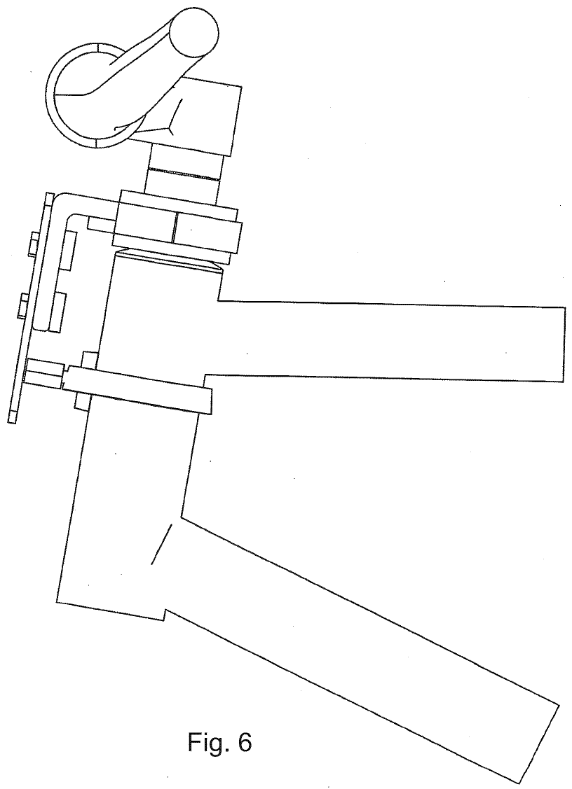

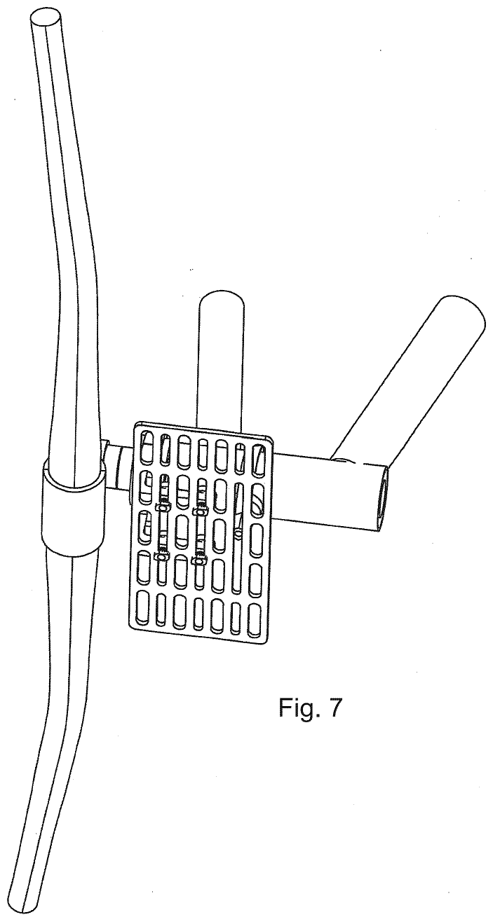

Referring to FIGS. 1-7, several views of two PALS-type panel mounting systems with each utilizing a specifically configured PALS-type panel are illustrated. Both systems are configured to mount to a steering system of a bicycle. An embodiment can be configured to be mounted directly to a handlebar referred to herein as the LIBARATOR. Another embodiment can be configured to be mounted to a fork steerer tube referred to herein as the ORBITER.

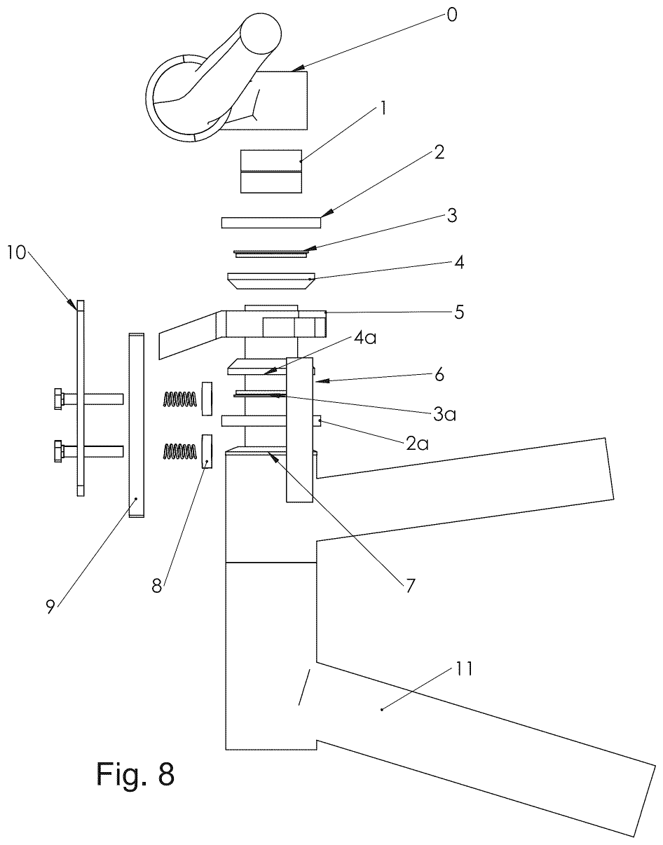

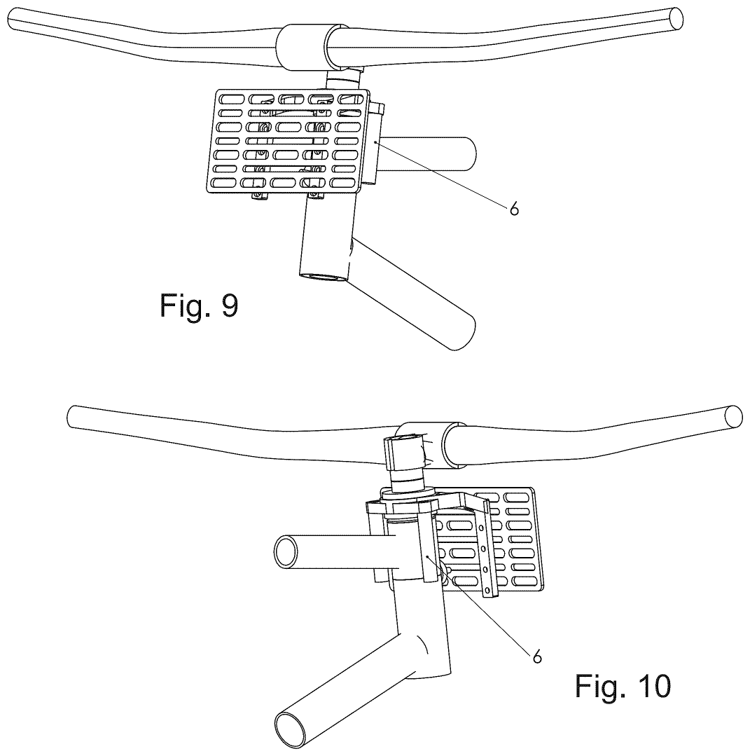

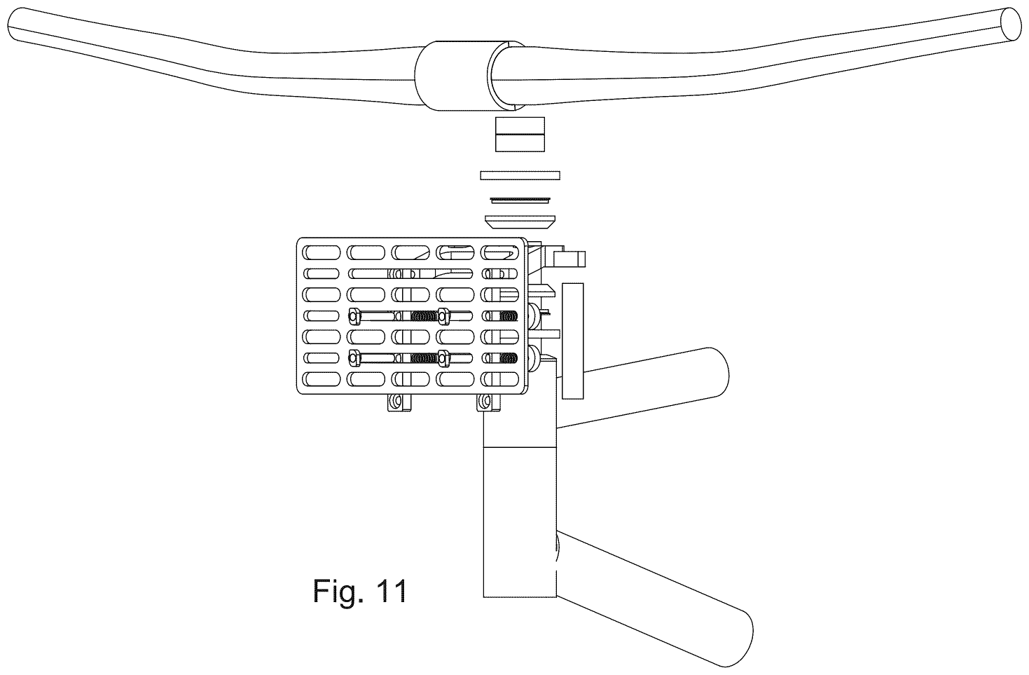

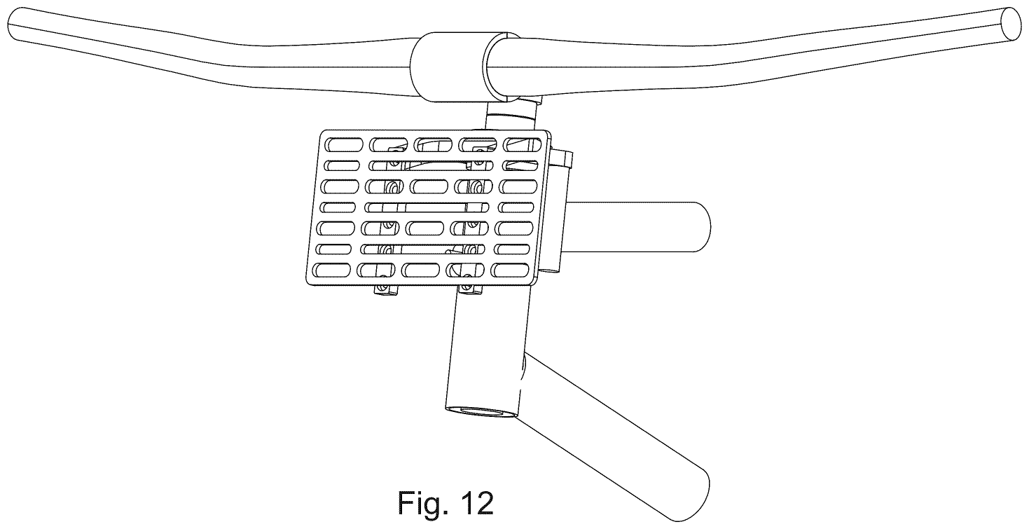

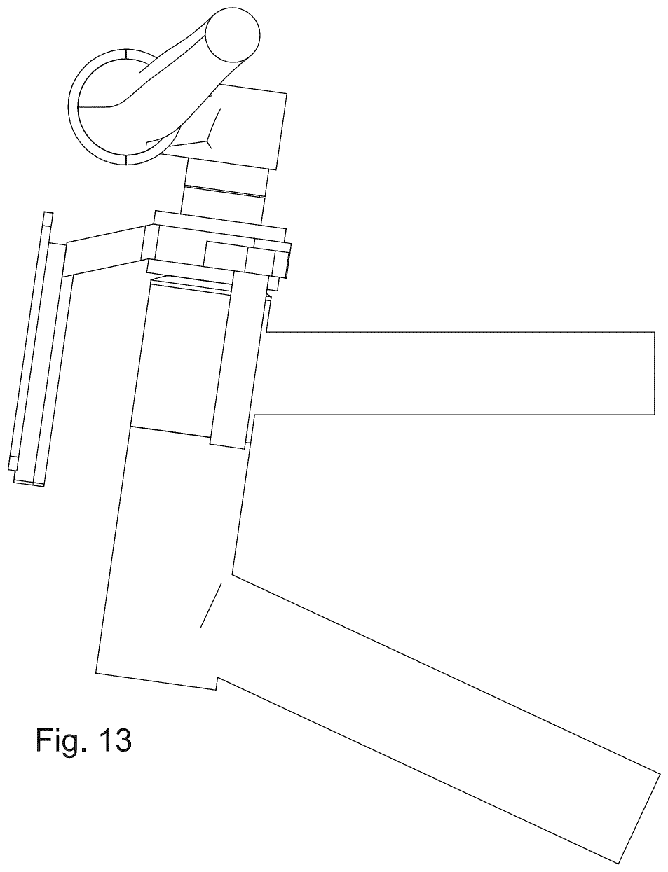

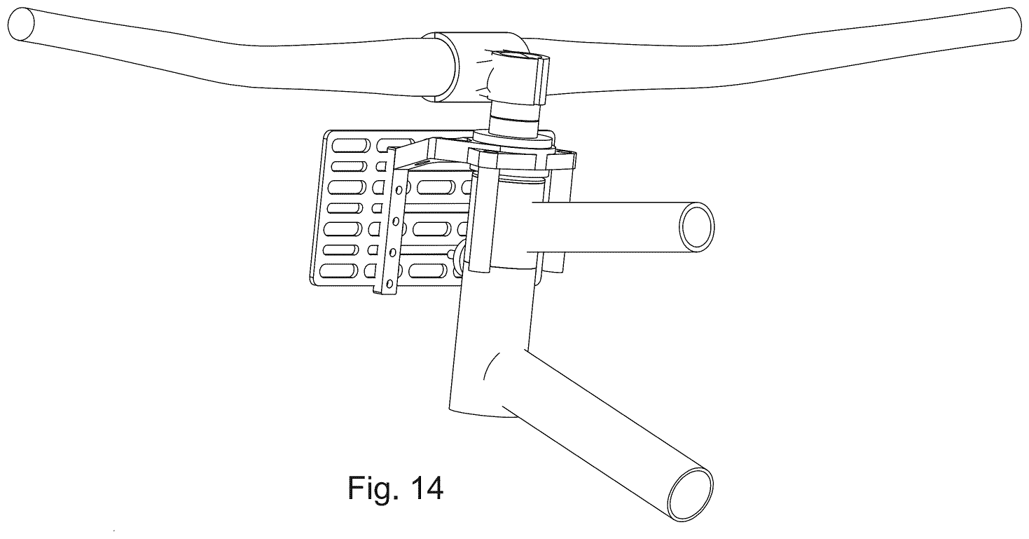

Referring to FIGS. 8-16, several views of a second embodiment of the ORBITER are illustrated.

A front view of the PALS-type panel is shown in FIG. 1. It can be comprised of any suitable rigid sheet material including plastic, metal, and composite. Size and thickness can vary depending on the application but in one embodiment the typically the panel is about 3.7″ wide by 7.7″ long. The illustrated embodiment comprises a plurality three differently sized slots distributed in an array: three long thin slots (2); six short thin slots (3); and twenty short wider slots (1). The thin slots accept 20 series T-nuts and bolts, and the wide slots accept 40 series T-nuts and bolts, and M6-M8 bolts. The large slots can further also be used to accept MOLLE-enabled pouches and attachments, as well as, standard handlebar bag straps. It is further appreciated that other connectors can be used, as appropriate, with the panel including twist ties, hook and loop straps, and zip ties.

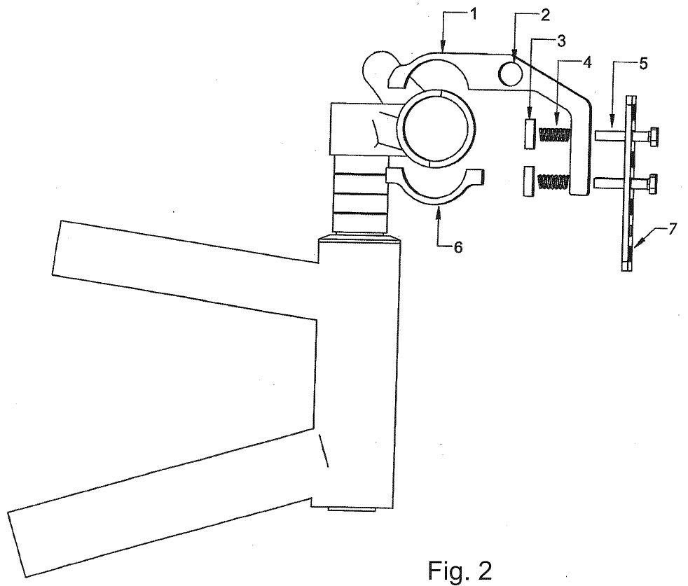

FIGS. 2-4 illustrate the LIBARATOR handlebar mounting system in conjunction with a PALS-type Panel (7). The system comprises a pair of generally L-shaped brackets (1) with lower arcuate clamps (6) and associated fasteners (not shown) that each attach in to the handlebar on opposite sides of the stem. Each bracket includes a generally horizontal leg that extends forwardly from the handlebar terminating in a distal arm that extends substantially vertically downwardly. One or more bolt holes are provided on the distal leg of each bracket to facilitate attachment of the PALS-type panel to the bracket. In at least some variations, the generally horizontal leg includes a horizontally-extending port hole (2) to which items can be attached that would have otherwise been secured to the handlebar.

The rigid PALS-type panel is typically attached to the brackets by way of a pair of T-bolts (5) that pass-through slots in the panel and the distal leg bolt holes, and are secured in place by a pair of thumb/wing nuts allowing tool-less coupling of the PALS-type panel to the brackets (3). In some variations, coil springs (4) are positioned over the bolts behind the panel and in front of the nuts to provide tensioning of the panel/bracket bolt connections.

When in use, the panel and consequently anything that is attached to the panel turns with the handlebar and front wheel of a bike to which it is mounted. This is desirable in some circumstances, but not in others.

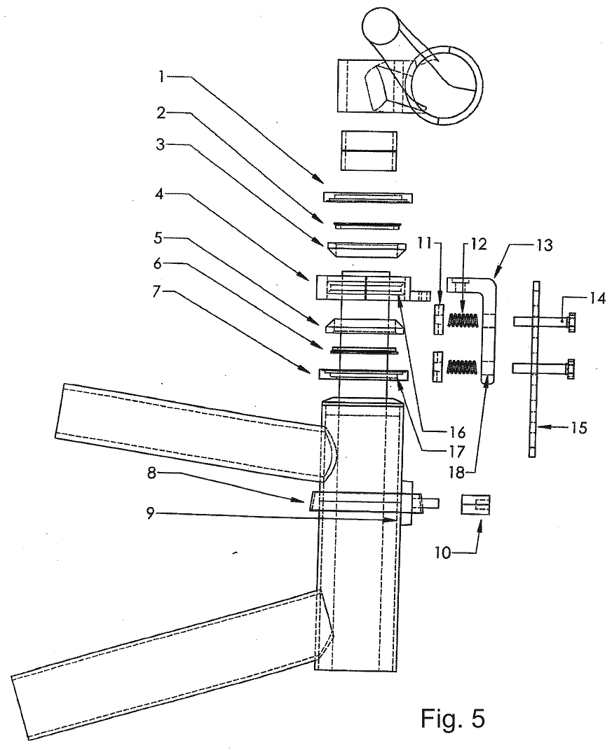

Referring to FIGS. 5-7, the ORBITER handlebar mounting system in conjunction with a PALS-type Panel (15) is illustrated. The annular main body (16) of the system is received over the steerer tube of a front fork as it extends above the head tube of a bicycle frame replacing one or more steering tube spacers that are often used on bicycle steering systems. One or more headset bearing assemblies (3 & 6) are received in the main body the permit it to rotate freely relative to the steerer tube. Top and bottom bearings assemblies are shown in the figures, but variations with a single bearing assembly is contemplated as well. The bearing assemblies and main body are sandwiched between upper and lower compression rings (2 & 6), which transfer the compressive load of the fixedly mounted stem to the bearing assemblies' inner races thereby permitting the outer races and the main body to rotate freely. As applicable upper and lower annular dust covers (1 & 7) may also be provided.

A tab extends horizontally and radially out the front of the annular main body. The tab includes a vertical bore that aligns with a corresponding vertical bore on the foot of an L-shaped Mounting Bracket (13) permitting the mounting bracket to be secured to the main body. A leg extends vertically downwardly from the foot of the L-shaped bracket that includes two or more bolt holes (18) to mount the PALS-type panel (15) to the mounting bracket in a similar manner as described above for the LIBARATOR by way of T-bolts (14), thumb/wing nuts (11) and tensioning springs (12).

As can be appreciated, the PALS-type panel and the main body is free to rotate relative to the front wheel, fork and handlebar, but to fix the panel in a forward orientation relative to the bicycle frame and the rest of the bike, the panel is fixedly connected to bike's headtube by way of a clamp assembly secured around the headtube and coupled with a slot in the PALS-type panel. The headtube clamp assembly is not subject to significant loads and, as such, need not be particularly robust. In some variations, the assembly can simply comprise a zip tie. In the illustrated variation, however, the clamp assembly comprises a rubber/elastomeric Voile-style strap (8) that is wrapped around the head tube with a threaded stud (9) partially enclosed in a rubber foot at its proximal end extending generally horizontally from the strap. The flexible strap allows the assembly to be fit around head tubes of varying dimensions and shapes. The elastomeric/rubber composition of the strap allows it to frictionally grip the headtube surface preventing it from shifting or rotating on the headtube. The threaded stud is received through a slot in the panel and secured in place suitable nut (10). Accordingly, once secured to the headtube, the PALS-type panel and anything mounted to it will remain aligned with the bike's frame and forward facing no matter how much the front wheel is turned. Further, the steering of the bicycle will not be affected by the weight of the articles attached to the panel.

In some variations the headtube clamp assembly can be replaced by a threaded boss or stud that is permanently affixed to the headtube.

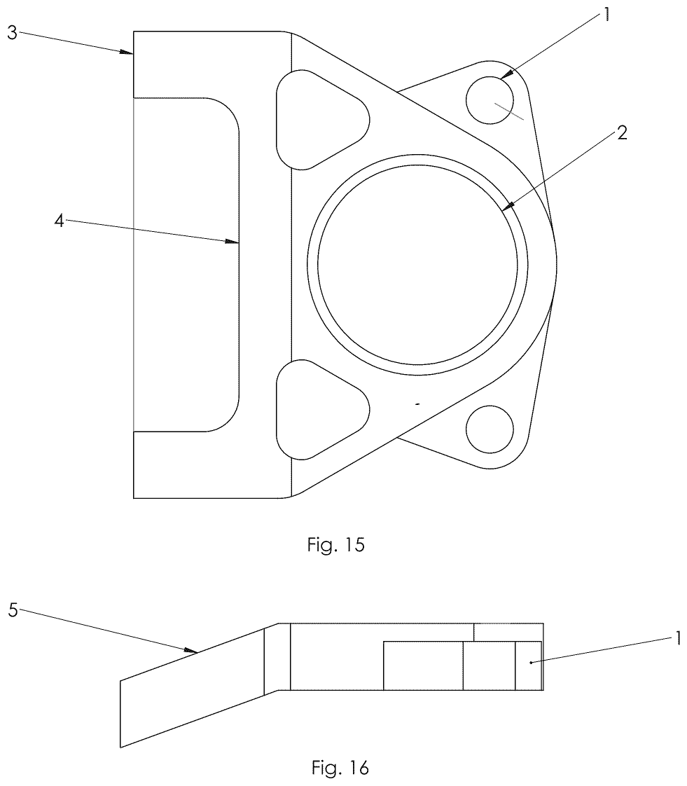

Referring to FIGS. 8-14, detailed diagrams of a second example embodiment of the ORBITER are illustrated. As generally shown, the second embodiment ORBITER can include, but is not limited to, a one or more standard stem spacers (1), a top bearing cap (2), a lower bearing cap (2a), a standard headset compression ring (3), a lower compression ring (3a), a standard headset bearing (4), a lower headset bearing (4a), an orbiter body (5), an adjustable stabilization mechanism (6), a quick detach assembly (8) fixing the PALS panel to the orbiter mount arms which can be bolted to the orbiter body, and one or more mount arms (9). The second embodiment ORBITER can be configured to be secured to a steerer tube of a bike. A PALS-type panel (10) can be secured to the mount arms (9) via the quick detach assembly (8). A handle bar assembly (0), a top headset cap (7) preinstalled on a bike and a bike frame (11) are shown for reference and how components may interface with the bike. The adjustable stabilization mechanism (6) can be vertically bolted to the orbiter body partially sheathed inside designated tabs (see FIG. 15) to prevent a rotation of the mount while under use/riding by bracing off the frame at the head, down and top tube junction(s).

Referring to FIGS. 15-16, a top view and a side view of the orbiter body of FIGS. 8-14 are illustrated. A tab (1) can be cut out for the stabilization mechanism (shown in FIGS. 8-14) to be bolted to the orbiter body. The orbiter body can include upper and lower headset bearing seats (2). Mounting arms can be bolted to a front (3) of the orbiter body. The orbiter body can include a channel (4) cut out to allow for routing of bike cables (e.g., brake, shift, electronics, etc.). As can be appreciated the channel (4) can be designed to facilitate free movement of cables while steering and can help prevent cables from getting caught on the PALS-type panel or attached accessories. A sloped front (5) of the orbiter body can allow for vertical clearance for handlebars to not pinch cables routed through the channel (4), handlebar bags, or other accessories mounted to the second embodiment ORBITER.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A mounting system for securing a PALS-type rigid panel to a bicycle, the mounting system comprising:
a pair of brackets adapted to mount to a handlebar on either side of a stem;
a plurality of attachment assemblies, each attachment assembly including a T-bolt, a spring, and a nut; and
a PALS-type rigid panel coupled to the pair of brackets by the plurality of attachment assemblies.

2. The mounting system of claim 1, wherein the pair of brackets each include a port hole through the bracket to permit an accessory attachment thereto.

3. The mounting system of claim 1, wherein the PALS-type rigid panel is defined by a substantially rectangular shape having a first set of slots, a second set of slots, and a third set of slots.

4. The mounting system of claim 3, wherein the first set of slots and the second set of slots are adapted to interface with 20 series T-nuts.

5. The mounting system of claim 4, wherein the first set of slots have a first length and the second set of slots have a second length, where the first length is different than the second length.

6. The mounting system of claim 3, wherein the third set of slots is adapted to interface with 40 series T-nuts.
